(19) United States
(12) Patent Application Publication
(10) Pub. No.: US 2023/0301224 A1
(43) Pub. Date: Sep. 28, 2023

(54) PRECISION GRAIN SOWING DEVICE CAPABLE OF UNIFORMLY DISCHARGING GRAIN SEEDS

(71) Applicant: Anhui Agricultural University, Hefei City (CN)

(72) Inventors: Liangfei FANG, Hefei City (CN); Kuan QIN, Hefei City (CN); Jun GE, Hefei City (CN); Chengmao CAO, Hefei City (CN); Haijun BI, Hefei City (CN); Yan SUN, Hefei City (CN); Zhengmin WU, Hefei City (CN)

(21) Appl. No.: 18/183,270

(22) Filed: Mar. 14, 2023

(30) Foreign Application Priority Data
Mar. 24, 2022 (CN) 202210292150 .9

(51) Int. Cl. A01C 7/10; A01C 7/20

(52) U.S. Cl. CPC A01C 7/102; A01C 7/20

(57) ABSTRACT

The present disclosure is suitable for the technical field of grain seed sowing, and provides a precision grain seed sowing device capable of uniformly discharging grain seeds. The sowing device comprises a grain seed supplying mechanism, a grain seed conveying mechanism and a grain seed discharging mechanism, wherein the grain seed supplying mechanism is used for providing grain seeds to the grain seed conveying mechanism for sowing, and the grain seed discharging mechanism is used for discharging the grain seeds uniformly provided by the grain seed conveying mechanism; the grain seed conveying mechanism comprises a grain seed conveying assembly and a grain seed replenishing assembly, the grain seed conveying assembly is used for uniformly providing the grain seeds for the grain seed discharging mechanism, and when an empty groove condition appears in the process that the grain seed conveying assembly provides the grain seeds for the grain seed discharging mechanism.

### CROSS-REFERENCE TO RELATED APPLICATION

This patent application claims the benefit and priority of Chinese Patent Application No. 202210292150.9 filed with the China National Intellectual Property Administration on Mar. 24, 2022, the disclosure of which is incorporated by reference herein in its entirety as part of the present application.

### TECHNICAL FIELD

The present disclosure belongs to the technical field of grain seed sowing, in particular to a precision grain seed sowing device capable of uniformly discharging grain seeds.

### BACKGROUND

Living animals and plants are objects of agricultural labor, and the obtained products are animals and plants. In the production process of agricultural and sideline products, when crop seeds need to be sown, the seeds are evenly and equally buried in soil. In order to realize the above functions, a sowing device is generally used. The sowing device is a planting machine with the crop seeds as sowing objects. Through the sowing device, the agricultural production efficiency is improved to a certain extent. However, with the continuous development of agricultural production technology, the performance requirements of the sowing device become higher and higher.

A precision seeder is provided in the published technology with the publication number of CN215223037U. The seeder includes a storage box, a blanking channel, a seed metering shell, a discharging channel, a rotating disk, seed conveying grooves, a rotating shaft and a motor. The storage box, the blanking channel, the seed metering shell and the discharging channel are sequentially connected from top to bottom and internally communicated with one another. The rotating disk is located inside the seed metering shell, and a plurality of seed conveying grooves are uniformly formed in the outer edge of the rotating disk. In the seeder of the above technical scheme, seeds fall into the seed conveying grooves of the rotating disc under the action of gravity. With the rotation of the rotating disc, when the seed conveying groove in which the seeds are placed is turned to the bottom, the seeds flow out from the discharging channel. However, in the scheme, with the rotation of the rotating disc, some seed conveying grooves may be empty, so that grain seeds are discharged unevenly during sowing, resulting in empty holes during sowing.

### SUMMARY

The present disclosure aims to provide a precision grain seed sowing device capable of uniformly discharging grain seeds to solve the problems proposed in the background art.

In order to achieve the above-mentioned purpose, the present disclosure provides the following technical solutions.

Disclosed is a precision grain seed sowing device capable of uniformly discharging grain seeds;the sowing device includes a grain seed supplying mechanism, a grain seed conveying mechanism and a grain seed discharging mechanism, wherein the grain seed conveying mechanism includes a grain seed conveying assembly and a grain seed replenishing assembly, the grain seed conveying assembly is configured for uniformly providing grain seeds for the grain seed discharging mechanism, and when an empty groove condition appears in the process that the grain seed conveying assembly provides the grain seeds for the grain seed discharging mechanism, the grain seed replenishing assembly replenishes grain seeds to the grain seed discharging mechanism;
the grain seed conveying assembly includes a fixed shell and a conveying ring seat, wherein the conveying ring seat is arranged in the shell and rotated coaxially with a driving shaft;
and a plurality of seed conveying grooves are uniformly formed in the conveying ring seat;
along the rotation direction of the conveying ring seat, a grain seed discharging channel included in the grain seed discharging mechanism is located behind an articulated shaft;
during the rotation of the conveying ring seat, when grain seeds are present in the current seed conveying groove being discharged and after a push-pull piece passes a rotating plate included in the grain seed replenishing assembly, the grain seeds in the current seed conveying groove are discharged from the grain seed discharging channel into a grain seed discharging cavity. When the current seed conveying groove being discharged is an empty groove, before the push-pull piece passes the rotating plate, the guide part of the push-pull piece pushes the rotating plate to rotate around the articulated shaft, so that the bottom of the rotating plate is far away from an opening of a grain seed replenishing bin, and the grain seeds in the grain seed replenishing bin are discharged into the grain seed discharging cavity.

In an embodiment provided by the present disclosure, a fixed ring is further arranged in the shell and rotated coaxially with the driving shaft. A guide rail ring is fixedly installed on the inner circle surface of the fixed ring. The guide rail ring is configured for positioning the end position of the push-pull piece in the current seed conveying groove after seed discharging after the grain seeds in the seed conveying groove are discharged, so that a space for receiving new grain seeds is formed in the seed conveying groove. When the seed conveying groove in the current space moves through a top channel of the shell, the grain seeds conveniently enter the current seed conveying groove, so that the grain seeds can be stored in the current seed conveying groove, and the grain seed conveying process of the next working procedure is facilitated.

In an embodiment provided by the present disclosure, a support ring seat is further arranged in the shell and rotated coaxially with the driving shaft. A plurality of push-pull pieces are uniformly installed on the support ring seat, and the plurality of push-pull pieces correspond to the plurality of seed conveying grooves one by one. The end of each push-pull piece extends into the corresponding seed conveying groove. According to the position of the end of the push-pull piece in the seed conveying groove, the grain seeds can be stored in the seed conveying groove, or the grain seeds in the seed conveying groove can be pushed out by the push-pull piece.

In an embodiment provided by the present disclosure, each push-pull piece includes a push-pull rod and a support rod elastically connected with the push-pull rod, wherein the support rod is fixedly installed on the support ring seat, and the end of the push-pull rod extends into the corresponding seed conveying groove. The guide part is arranged on the push-pull rod. When the guide part abuts against the guide rail ring, the position of the end of the push-pull rod in the seed conveying groove is changed so that a space for receiving new grain seeds is formed in the seed conveying groove.

In an embodiment provided by the present disclosure, a rectangular sliding block is slidably arranged in the push-pull rod and supported by a support spring. The support rod extending into the inner cavity of the push-pull rod is fixedly connected with the rectangular sliding block, so that the push-pull rod is elastically connected with the support rod. When the guide part does not abut against the guide rail ring, the push-pull rod has a trend to completely abut against the seed conveying groove under the support of the elastic connection. It can be understood that when the grain seeds are present in the seed conveying groove, the push-pull rod has a movement trend of completely abutting against the seed conveying groove, but the guide part cannot abut against the inner wall of the fixed ring because of the grain seeds in the seed conveying groove. On the contrary, when the grain seeds are not present in the seed conveying groove, that is, when the current seed conveying groove is in an empty groove condition, the guide part abuts against the inner wall of the fixed ring, and the end of the push-pull rod completely abuts against the seed conveying groove.

In an embodiment provided by the present disclosure, the guide part includes a support pillar fixedly installed on the push-pull rod,a support sliding block is fixedly installed on the support pillar,and the end of the support sliding block facing the fixed ring is provided with a smooth layer, so that when the guide part abuts against the fixed ring or the guide rail ring, the friction force of the contact surface is reduced, and the energy consumption is saved.

In an embodiment provided by the present disclosure, the grain seed discharging mechanism includes a grain seed discharging tube, a grain seed discharging cavity is formed in the grain seed discharging tube, and the grain seed discharging cavity is communicated with the shell through the grain seed discharging channel. When the seed conveying groove is aligned with the grain seed discharging channel, the grain seeds in the current seed conveying groove enter the grain seed discharging cavity through the grain seed discharging channel under the elastic pushing action of the corresponding push-pull piece, and then the grain seeds are discharged. Certainly, the current seed conveying groove may also be an empty groove. In the case of the empty groove condition, the grain seeds are discharged through the grain seed replenishing assembly.

In an embodiment provided by the present disclosure, the grain seed replenishing assembly includes the grain seed replenishing bin,the bottom of the grain seed replenishing bin extends into the grain seed discharging cavity,and the opening of the grain seed replenishing bin is formed in the bottom of the grain seed replenishing bin;

an upper part of the rotating plate extends into the shell, a lower part of the rotating plate extends into the grain seed discharging cavity,and the waist portion of the rotating plate is rotatably arranged on the shell through the articulated shaft;the fixed ring is provided with an elastic guide piece;a top of the rotating plate is supported by and slidably arranged on the elastic guide piece; when the elastic guide piece is in an unstressed state, the bottom of the rotating plate abuts against the opening of a grain seed replenishing bin;when the elastic guide piece is in an unstressed state, the top of the rotating plate extends to the inner side of the fixed ring, so that the guide part can abut against the top of the rotating plate when the empty groove condition appears in the seed conveying groove. Therefore, when the guide part continues to stir a top of the rotating plate, the bottom of the rotating plate is far away from the opening of a grain seed replenishing bin, so that the grain seeds in the grain seed replenishing bin are discharged into the grain seed discharging cavity, and replenishing and grain seed discharging are realized.

In an embodiment provided by the present disclosure, the top channel of the shell is communicated with the grain seed supplying mechanism, so that the grain seed supplying mechanism can provide the grain seeds into the shell in time;
the grain seed supplying mechanism includes a grain seed bin, and the grain seed bin is fixedly installed above the shell, wherein the grain seed bin is fixedly installed on a top of a frame, and the grain seed conveying mechanism is arranged at a middle of the frame;
the grain seed bin is communicated with the top channel of the shell through a communication channel.

In an embodiment provided by the present disclosure, a guide rail groove is formed in the conveying ring seat;the guide rail groove is provided with a guide block and is connected to the guide block through a connecting spring set;a support bracket in sliding fit with the rotating plate is rotatably arranged on the guide block;

an upper part of the rotating plate is slidably arranged on the support bracket. The connecting spring set includes a first spring and a second spring. It can be understood that the first spring is used for connecting one side of the guide block with one end of the guide rail groove, and the second spring is used for connecting the other side of the guide block with the other end of the guide rail groove. The guide part pushes the rotating plate to turn, and after the guide part releases the rotating plate, the connecting spring set is used for resetting the rotating plate.

Compared with the prior art, in the sowing device provided by the present disclosure, when the grain seeds are present in the current seed conveying groove being discharged and after the push-pull piece passes the rotating plate, the grain seeds in the current seed conveying groove are discharged from the grain seed discharging channel into the grain seed discharging cavity. When the current seed conveying groove being discharged is an empty groove, before the push-pull piece passes the rotating plate, the guide part of the push-pull piece pushes the rotating plate to rotate around the articulated shaft, so that the bottom of the rotating plate is far away from the opening of a grain seed replenishing bin, and the grain seeds in the grain seed replenishing bin are discharged into the grain seed discharging cavity. When the empty groove condition appears for the seed conveying grooves being discharged, the grain seeds are replenished to the grain seed discharging mechanism in time through the grain seed replenishing assembly, so that the continuity and uniformity during sowing of the grain seeds are ensured.

### BRIEF DESCRIPTION OF THE DRAWINGS

To describe the technical solutions in the embodiments of the present disclosure more clearly, the following briefly describes the attached figures required for describing the embodiments or the prior art. Obviously, the attached figures in the following description show merely some embodiments of the present disclosure.

FIG. 1 is a schematic structural diagram of a precision grain seed sowing device capable of uniformly discharging grain seeds in the first grain seed discharging state.

FIG. 2 is a schematic structural diagram of a precision grain seed sowing device capable of uniformly discharging grain seeds in the second grain seed discharging state.

FIG. 3 is a structural diagram of a grain seed conveying mechanism in the sowing device according to the embodiment of the present disclosure.

FIG. 4 is a structural diagram of a shell in the sowing device according to an embodiment of the present disclosure.

FIG. 5 is a partially enlarged structural schematic diagram of part A in FIG. 2.

FIG. 6 is a partial schematic diagram of a push-pull piece in the sowing device according to the embodiment of the present disclosure.

FIG. 7 is a space schematic diagram of a push-pull piece in the sowing device according to the embodiment of the present disclosure.

FIG. 8 is a space schematic diagram of a supporting piece in the sowing device according to the embodiment of the present disclosure.

Reference signs: 100, shell; 101, fixed ring; 102, guide rail ring; 103, driving shaft; 104, guide rail groove; 105, guide block; 106, support bracket; 107, connecting spring set; 200, conveying ring seat; 201, support ring seat; 202, push-pull rod; 203, seed conveying groove; 204, support sliding block; 205, support rod; 206, smooth layer; 207, support pillar; 208, support spring; 209, rectangular sliding block; 300, road wheel; 400, grain seed replenishing bin; 401, opening of a grain seed replenishing bin; 500, frame; 600, furrow plough; 700, rotating plate; 701, articulated shaft; 800, grain seed bin; 801, communication channel; 900, grain seed discharging tube; 901, grain seed discharging cavity; and 902, grain seed discharging channel.

### DETAILED DESCRIPTION OF THE EMBODIMENTS

Embodiments of the present disclosure are described in detail below.

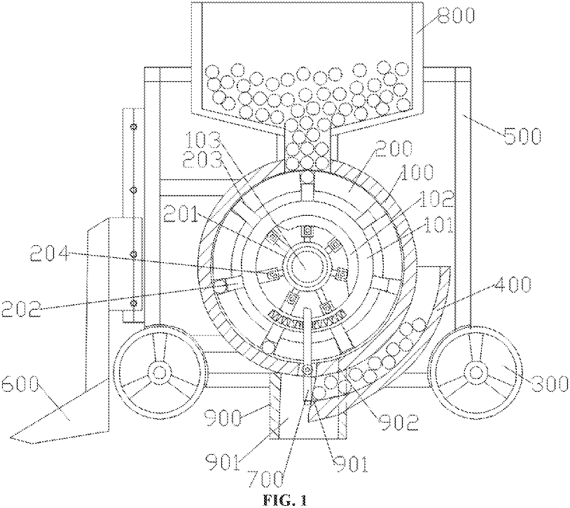

As shown in FIG. 1, in one embodiment provided by the present disclosure, a precision grain seed sowing device capable of uniformly discharging grain seeds is disclosed. The sowing device includes a grain seed supplying mechanism, a grain seed conveying mechanism and a grain seed discharging mechanism. The grain seed supplying mechanism is used for providing grain seeds to the grain seed conveying mechanism for sowing, and the grain seed discharging mechanism is used for discharging the grain seeds uniformly provided by the grain seed conveying mechanism so as to achieve the effect of uniform grain seed discharging.

Wherein, in the embodiment of the present disclosure, the grain seed conveying mechanism includes a grain seed conveying assembly and a grain seed replenishing assembly. The grain seed conveying assembly is used for uniformly providing grain seeds for the grain seed discharging mechanism, and when an empty groove condition appears in the process that the grain seed conveying assembly provides the grain seeds for the grain seed discharging mechanism, the grain seeds are replenished to the grain seed discharging mechanism through the grain seed replenishing assembly, so that the continuous and uniform grain seed discharging of the grain seed discharging mechanism is ensured, and the continuity and uniformity of the grain seeds during sowing is ensured.

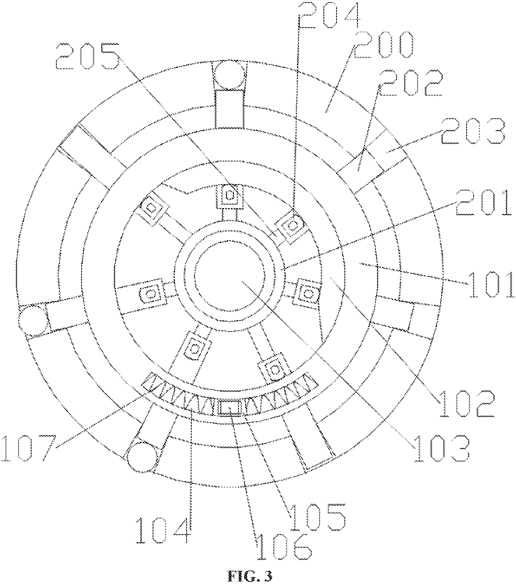

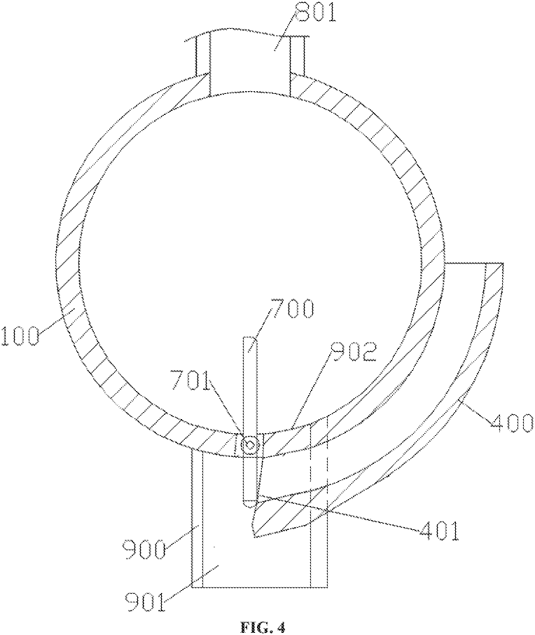

Specifically, as shown in FIG. 1, FIG. 3 and FIG. 4, in a preferred embodiment provided by the present disclosure, the grain seed conveying assembly includes a fixed shell 100 and a conveying ring seat 200, wherein the conveying ring seat 200 is arranged in the shell 100 and rotated coaxially with the driving shaft 103; and a plurality of seed conveying grooves 203 are uniformly formed in the conveying ring seat 200.

The conveying ring seat 200 is arranged in the shell 100 androtated coaxially with the driving shaft 103. In the embodiment, the top channel of the shell 100 is communicated with the grain seed supplying mechanism, so that the grain seed supplying mechanism can provide the grain seeds into the shell 100 in time.

Further, in the embodiment of the present disclosure, along the rotation direction of the conveying ring seat 200, a grain seed discharging channel 902 included in the grain seed discharging mechanism is located behind an articulated shaft 701.

During the rotation of the conveying ring seat 200, when grain seeds are present in the current seed conveying groove 203 being discharged and after a push-pull piece passes a rotating plate 700 included in the grain seed replenishing assembly, the grain seeds in the current seed conveying groove 203 are discharged from the grain seed discharging channel 902 into a grain seed discharging cavity 901. When the current seed conveying groove 203 being discharged is an empty groove, before the push-pull piece passes the rotating plate 700, the guide part of the push-pull piece pushes the rotating plate 700 to rotate around the articulated shaft 701, so that the bottom of the rotating plate 700 is far away from an opening of a grain seed replenishing bin 401, and the grain seeds in a grain seed replenishing bin 400 are discharged into the grain seed discharging cavity 901.

Specifically, in the embodiment of the present disclosure, a support ring seat 201 is further arranged in the shell 100 and rotated coaxially with the driving shaft 103. A plurality of push-pull pieces are uniformly installed on the support ring seat 201, and the push-pull pieces correspond to the seed conveying grooves 203 one by one. The end of each push-pull piece extends into the corresponding seed conveying groove 203. According to the position of the end of the push-pull piece in the seed conveying groove 203, the grain seeds can be stored in the seed conveying groove 203, or the grain seeds in the seed conveying groove 203 can be pushed out by the push-pull piece.

Further, in the embodiment of the present disclosure, a fixed ring 101 is arranged in the shell 100 and rotated coaxially with the driving shaft 103. A guide rail ring 102 is fixedly installed on a right inner surface of the fixed ring 101. The guide rail ring 102 is used for positioning the end position of the push-pull piece in the current seed conveying groove 203 after seed discharging after the grain seeds in the seed conveying groove 203 are discharged, so that a space for receiving new grain seeds is formed in the seed conveying groove 203. When the seed conveying groove 203 in the current space moves through the top channel of the shell 100, the grain seeds conveniently enter the current seed conveying groove 203, so that the grain seeds can be stored in the current seed conveying groove 203, and the grain seed conveying process of the next working procedure is facilitated.

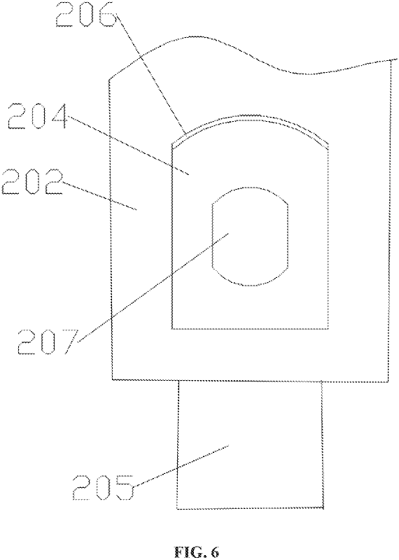

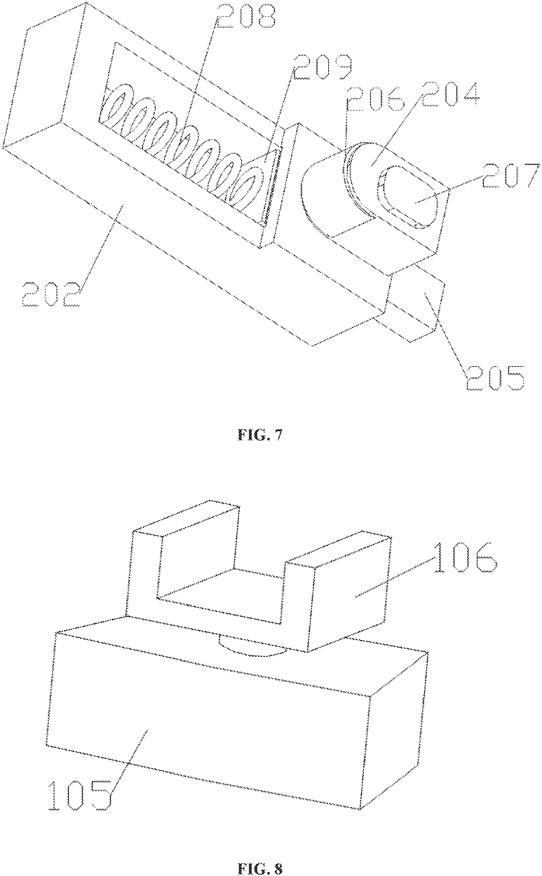

As shown in FIG. 3, FIG. 6 and FIG. 7, in the embodiment of the present disclosure, each push-pull piece includes a push-pull rod 202 and a support rod 205 elastically connected with the push-pull rod 202, wherein the support rod 205 is fixedly installed on the support ring seat 201, and the end of the push-pull rod 202 extends into the corresponding seed conveying groove 203. The guide part is arranged on the push-pull rod 202. When the guide part abuts against the guide rail ring 102, the position of the end of the push-pull rod 202 in the seed conveying groove 203 is changed so that a space for receiving new grain seeds is formed in the seed conveying groove 203.

Preferably, as shown in FIG. 6 and FIG. 7, in the embodiment of the present disclosure, a rectangular sliding block 209 is slidably arranged in the push-pull rod 202 and supported by a support spring 208. The support rod 205 extending into the inner cavity of the push-pull rod 202 is fixedly connected with the rectangular sliding block 209, so that the push-pull rod 202 is elastically connected with the support rod 205. When the guide part does not abut against the guide rail ring 102, the push-pull rod 202 has a trend to completely abut against the seed conveying groove 203 under the support of the elastic connection. It can be understood that when the grain seeds are present in the seed conveying groove 203, the push-pull rod 202 has a movement trend of completely abutting against the seed conveying groove 203, but the guide part cannot abut against the inner wall of the fixed ring 101 because of the grain seeds in the seed conveying groove 203. On the contrary, when the grain seeds are not present in the seed conveying groove 203, that is, when the current seed conveying groove 203 is in an empty groove condition, the guide part abuts against the inner wall of the fixed ring 101, and the end of the push-pull rod 202 completely abuts against the seed conveying groove 203.

In a preferable embodiment of the present disclosure, the guide part includes a support pillar 207 fixedly installed on the push-pull rod 202. A support sliding block 204 is fixedly installed on the support pillar 207. The end of the support sliding block 204 facing the fixed ring 101 is provided with a smooth layer 206, so that when the guide part abuts against the fixed ring 101 or the guide rail ring 102, the friction force of the contact surface is reduced, and the energy consumption is saved.

In the embodiment of the present disclosure, the grain seed supplying mechanism includes a grain seed bin 800, and the grain seed bin 800 is fixedly installed above the shell 100, wherein the grain seed bin 800 is fixedly installed on the top of a frame 500, and the grain seed conveying mechanism is arranged at the middle of the frame 500.

In the embodiment of the present disclosure, the support ring seat 201 is fixedly installed on a driving shaft 103, and the driving shaft 103 is driven by an independent motor.

Specifically, in the embodiment of the present disclosure, the grain seed bin 800 is communicated with the top channel of the shell 100 through a communication channel 801. When the space formed in the seed conveying groove 203 for receiving the grain seeds corresponds to the top channel of the shell 100, the grain seeds in the grain seed bin 800 fall into the corresponding seed conveying groove 203 after passing through the communication channel 801, so that when the conveying ring seat 200 rotates relative to the shell 100, the outer wall of the conveying ring seat 200 slides against the inner wall of the shell 100. The seed conveying groove 203 passes the communication channel 801, and the guide part is also separated from the guide rail ring 102. When the grain seeds are present in the seed conveying groove, the seed grins in the seed conveying groove still support the end of the push-pull rod 202. At this time, the guide part of the push-pull rod 202 is not in contact with the inner wall of the fixed ring 101. On the contrary, when an empty groove appears in the seed conveying groove, that is, when no grain seed is present in the seed conveying groove, the end of the push-pull rod 202 completely abuts against the seed conveying groove 203. At this time, the guide part abuts against the inner ring wall of the fixed ring 101.

For the seed conveying grooves 203 without an empty groove, when the seed conveying groove 203 is aligned with the grain seed discharging mechanism, the elastic force of the push-pull piece pushes the grain seeds in the current seed conveying groove 203 being discharged and fall into the discharging mechanism so as to realize grain seed discharging.

Correspondingly, when the empty groove condition appears, the grain seed replenishing assembly is used for replenishing the grain seeds, and when the time node of grain seed replenishing is the current seed conveying groove 203 in the empty groove condition being aligned with the discharging mechanism, the grain seed replenishing assembly provides the grain seeds for the discharging mechanism at this time to replace the current empty groove to discharge the grain seeds.

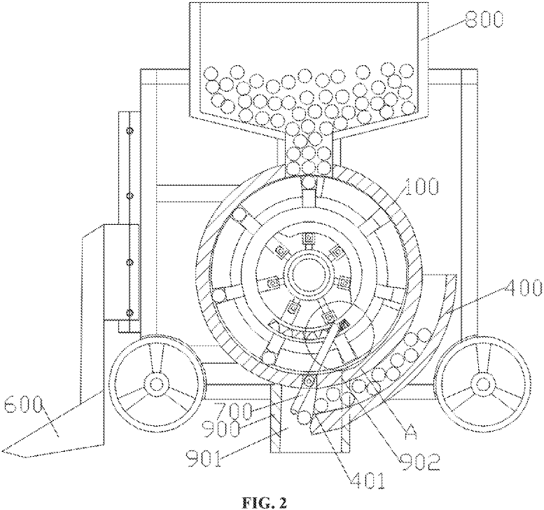

Continuously referring to FIG. 1 and FIG. 2, in the embodiment of the present disclosure, the discharging mechanism is arranged at the bottom of the frame 500, and the discharging mechanism is located at the bottom of the shell 100.

Further, in the embodiment of the present disclosure, road wheels 300 are arranged at the bottom of the frame 500. Through the road wheels 300, the sowing device is convenient to move, and in the moving process, the sowing device is matched with the seed conveying mechanism to realize the effects of uniform seed discharging and uniform sowing of the grain seeds.

Further, in the present disclosure, the forward end of the frame 500 is fixedly provided with a furrow plough 600. The furrow plough 600 is used for ditching when the sowing device moves, and the grain seeds of the grain seed discharging mechanism fall into the sowing groove formed by furrowing.

Further, in the embodiment of the present disclosure, the driving shaft 103 can be driven by an independent motor, and the driving shaft 103 can also be linked with the road wheels 300, so that when the road wheels 300 walk, the driving shaft 103 is driven to rotate synchronously, thus realizing the effect of grain seed discharging during walking. Certainly, in practical application, it is preferable to adopt an independent motor for driving.

As shown in FIG. 1 to FIG. 5 and FIG. 8, in the embodiment of the present disclosure, the grain seed discharging mechanism includes a grain seed discharging tube 900, a grain seed discharging cavity 901 is formed in the grain seed discharging tube 900, and the grain seed discharging cavity 901 is communicated with the shell 100 through the grain seed discharging channel 902. When the seed conveying groove 203 is aligned with the grain seed discharging channel 902, the grain seeds in the current seed conveying groove 203 enter the grain seed discharging cavity 901 through the grain seed discharging channel 902 under the elastic pushing action of the corresponding push-pull piece, and then the grain seeds are discharged. Certainly, the current seed conveying groove 203 may also be an empty groove. In the case of the empty groove condition, the grain seeds are discharged through the grain seed replenishing assembly.

Further, in the embodiment of the present disclosure, the grain seed replenishing assembly includes a grain seed replenishing bin 400. The bottom of the grain seed replenishing bin 400 extends into the grain seed discharging cavity 901. The opening of a grain seed replenishing bin 401 is formed in the bottom of the grain seed replenishing bin 400.

As shown in FIG. 1, FIG. 2 and FIG. 4, the grain seed discharging channel 902 is located at the back of the opening of a grain seed replenishing bin 401. The grain seed discharging channel 902 is used for the grain seeds in the seed conveying groove 203 to enter the grain seed discharging cavity 901, and the opening of a grain seed replenishing bin 401 is used for the grain seeds in the grain seed replenishing bin 400 to enter the grain seed discharging cavity 901.

In the embodiment of the present disclosure, the upper part of the rotating plate 700 extends into the shell 100, the lower part of the rotating plate 700 extends into the grain seed discharging cavity 901,and the waist portion of the rotating plate 700 is rotatably arranged on the shell 100 through the articulated shaft 701. The fixed ring 101 is provided with an elastic guide piece. The top of the rotating plate 700 is supported by and slidably arranged on the elastic guide piece. When the elastic guide piece is in an unstressed state, the bottom of the rotating plate 700 abuts against the opening of a grain seed replenishing bin 401. When the elastic guide piece is in an unstressed state, the top of the rotating plate 700 extends to the inner side of the fixed ring 101, so that the guide part can abut against the top of the rotating plate 700 when the empty groove condition appears in the seed conveying groove 203. Therefore, when the guide part continues to stir the top of the rotating plate 700, the bottom of the rotating plate 700 is far away from the opening of a grain seed replenishing bin 401, so that the grain seeds in the grain seed replenishing bin 400 are discharged into the grain seed discharging cavity 901, and replenishing and grain seed discharging are realized.

Specifically, in the embodiment of the present disclosure, along the rotation direction of the conveying ring seat 200, the grain seed discharging channel 902 is located behind the articulated shaft 701, that is, during the rotation of the conveying ring seat 200, after the push-pull piece passes the rotating plate 700, the grain seeds in the current seed conveying groove 203 are discharged from the grain seed discharging channel 902 into the grain seed discharging cavity 901, and then the grain seeds are discharged. When the seed conveying groove 203 is an empty groove, before the push-pull piece passes the rotating plate 700, the guide part of the push-pull piece pushes the rotating plate 700 to rotate around the articulated shaft 701, so that the bottom of the rotating plate 700 is further far away from the opening of a grain seed replenishing bin 401, the grain seeds in the grain seed replenishing bin 400 are discharged into the grain seed discharging cavity 901, and replenishing and grain seed discharging are realized.

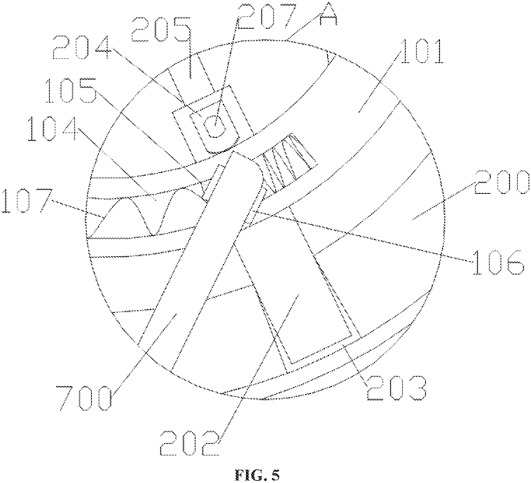

As shown in FIG. 5 and FIG. 8, in the embodiment of the present disclosure, a guide rail groove 104 is formed in the conveying ring seat 200. The guide rail groove 104 is provided with a guide block 105 and is connected to the guide block through a connecting spring set 107. A support bracket 106 in sliding fit with the rotating plate 700 is rotatably arranged on the guide block 105.

Preferably, in the embodiment of the present disclosure, the upper part of the rotating plate 700 is slidably arranged on the support bracket 106. The connecting spring set 107 includes a first spring and a second spring. It can be understood that the first spring is used for connecting one side of the guide block 105 with one end of the guide rail groove 104, and the second spring is used for connecting the other side of the guide block 105 with the other end of the guide rail groove 104. The guide part pushes the rotating plate 700 to turn, and after the guide part releases the rotating plate 700, the connecting spring set 107 is used for resetting the rotating plate 700.

Although the embodiments of the present disclosure have been disclosed above, the embodiments are not limited to the applications listed in the description and embodiments. It can be applied to various fields suitable for the present disclosure. Other modifications can be easily implemented by those skilled in the art. Therefore, the present disclosure is not limited to the specific details and the illustrations shown and described herein without departing from the general concept defined by the claims and the equivalents of the claims.

What is claimed is:

1. A precision grain seed sowing device capable of uniformly discharging grain seeds, comprising a grain seed supplying mechanism, a grain seed conveying mechanism and a grain seed discharging mechanism, wherein the grain seed conveying mechanism comprises a grain seed conveying assembly and a grain seed replenishing assembly, the grain seed conveying assembly is configured for providing grain seeds for the grain seed discharging mechanism, and when an empty groove condition appears in the process that the grain seed conveying assembly provides the grain seeds for the grain seed discharging mechanism, the grain seed replenishing assembly replenishes grain seeds to the grain seed discharging mechanism;
the grain seed conveying assembly comprises a fixed shell and a conveying ring seat, wherein the conveying ring seat is arranged in the shell and rotated coaxially with a driving shaft; and a plurality of seed conveying grooves are uniformly formed in the conveying ring seat;
along a rotation direction of the conveying ring seat, a grain seed discharging channel in the grain seed discharging mechanism is located behind an articulated shaft;
during the rotation of the conveying ring seat, when grain seeds are present in a current seed conveying groove being discharged and after a push-pull piece passes a rotating plate in the grain seed replenishing assembly, the grain seeds in the current seed conveying groove are discharged from the grain seed discharging channel into a grain seed discharging cavity; and when the current seed conveying groove being discharged is an empty groove, before the push-pull piece passes the rotating plate, a guide part of the push-pull piece pushes the rotating plate to rotate around the articulated shaft, so that a bottom of the rotating plate is far away from an opening of a grain seed replenishing bin, and the grain seeds in the grain seed replenishing bin are discharged into the grain seed discharging cavity.

2. The precision grain seed sowing device capable of uniformly discharging grain seeds according to claim 1, wherein a fixed ring is further arranged in the shell and rotated coaxially with the driving shaft, a guide rail ring is fixedly installed on an inner circle surface of oneside of the fixed ring, the guide rail ring is configured for positioning the end position of the push-pull piece in the current seed conveying groove after seed discharging after the grain seeds in the seed conveying groove are discharged, so that a space for receiving new grain seeds is formed in the seed conveying groove.

3. The precision grain seed sowing device capable of uniformly discharging grain seeds according to claim 2, wherein a support ring seat is further arranged in the shell and rotated coaxially with the driving shaft, a plurality of push-pull pieces are uniformly installed on the support ring seat, the plurality of push-pull pieces correspond to the plurality of seed conveying grooves one by one, and the end of each push-pull piece extends into a corresponding seed conveying groove.

4. The precision grain seed sowing device capable of uniformly discharging grain seeds according to claim 3, wherein each push-pull piece comprises a push-pull rod and a support rod elastically connected with the push-pull rod, wherein the support rod is fixedly installed on the support ring seat, and an end of the push-pull rod extends into the corresponding seed conveying groove, the guide part is arranged on the push-pull rod, and when the guide part abuts against the guide rail ring, a position of the end of the push-pull rod in the seed conveying groove is changed so that a space for receiving new grain seeds is formed in the seed conveying groove.

5. The precision grain seed sowing device capable of uniformly discharging grain seeds according to claim 4, wherein a rectangular sliding block is slidably arranged in the push-pull rod and supported by a support spring, and the support rod extending into an inner cavity of the push-pull rod is fixedly connected with the rectangular sliding block.

6. The precision grain seed sowing device capable of uniformly discharging grain seeds according to claim 5, wherein the guide part comprises a support pillar fixedly installed on the push-pull rod, a support sliding block is fixedly installed on the support pillar, and an end of the support sliding block facing the fixed ring is provided with a smooth layer.

7. The precision grain seed sowing device capable of uniformly discharging grain seeds according to claim 4, wherein the grain seed discharging mechanism comprises a grain seed discharging tube, a grain seed discharging cavity is formed in the grain seed discharging tube, and the grain seed discharging cavity is communicated with the shell through the grain seed discharging channel; when the seed conveying groove is aligned with the grain seed discharging channel, the grain seeds in the current seed conveying groove enter the grain seed discharging cavity through the grain seed discharging channel under an elastic pushing action of the corresponding push-pull piece, and then the grain seeds are discharged.

8. The precision grain seed sowing device capable of uniformly discharging grain seeds according to claim 7, wherein the grain seed replenishing assembly comprises the grain seed replenishing bin, a bottom of the grain seed replenishing bin extends into the grain seed discharging cavity, and the opening of the grain seed replenishing bin is formed in the bottom of the grain seed replenishing bin;
an upper part of the rotating plate extends into the shell, a lower part of the rotating plate extends into the grain seed discharging cavity, and a waist portion of the rotating plate is rotatably arranged on the shell through the articulated shaft; the fixed ring is provided with an elastic guide piece; a top of the rotating plate is supported by and slidably arranged on the elastic guide piece; when the elastic guide piece is in an unstressed state, the bottom of the rotating plate abuts against the opening of a grain seed replenishing bin; and when the elastic guide piece is in an unstressed state, the top of the rotating plate extends to an inner side of the fixed ring, so that the guide part is able to abut against the top of the rotating plate when the empty groove condition appears in the seed conveying groove.

9. The precision grain seed sowing device capable of uniformly discharging grain seeds according to claim 8, wherein a guide rail groove is formed in the conveying ring seat, the guide rail groove is provided with a guide block and is connected to the guide block through a connecting spring set, a support bracket in sliding fit with the rotating plate is rotatably arranged on the guide block, and the upper part of the rotating plate is slidably arranged on the support bracket.

10. The precision grain seed sowing device capable of uniformly discharging grain seeds according to claim 5, wherein the grain seed discharging mechanism comprises a grain seed discharging tube, a grain seed discharging cavity is formed in the grain seed discharging tube, and the grain seed discharging cavity is communicated with the shell through the grain seed discharging channel; when the seed conveying groove is aligned with the grain seed discharging channel, the grain seeds in the current seed conveying groove enter the grain seed discharging cavity through the grain seed discharging channel under an elastic pushing action of the corresponding push-pull piece, and then the grain seeds are discharged.

11. The precision grain seed sowing device capable of uniformly discharging grain seeds according to claim 10, wherein the grain seed replenishing assembly comprises the grain seed replenishing bin, a bottom of the grain seed replenishing bin extends into the grain seed discharging cavity, and the opening of the grain seed replenishing bin is formed in the bottom of the grain seed replenishing bin;
an upper part of the rotating plate extends into the shell, a lower part of the rotating plate extends into the grain seed discharging cavity, and a waist portion of the rotating plate is rotatably arranged on the shell through the articulated shaft; the fixed ring is provided with an elastic guide piece; a top of the rotating plate is supported by and slidably arranged on the elastic guide piece; when the elastic guide piece is in an unstressed state, the bottom of the rotating plate abuts against the opening of a grain seed replenishing bin; and when the elastic guide piece is in an unstressed state, the top of the rotating plate extends to an inner side of the fixed ring, so that the guide part is able to abut against the top of the rotating plate when the empty groove condition appears in the seed conveying groove.

12. The precision grain seed sowing device capable of uniformly discharging grain seeds according to claim 11, wherein a guide rail groove is formed in the conveying ring seat, the guide rail groove is provided with a guide block and is connected to the guide block through a connecting spring set, a support bracket in sliding fit with the rotating plate is rotatably arranged on the guide block, and the upper part of the rotating plate is slidably arranged on the support bracket.

13. The precision grain seed sowing device capable of uniformly discharging grain seeds according to claim 6, wherein the grain seed discharging mechanism comprises a grain seed discharging tube, a grain seed discharging cavity is formed in the grain seed discharging tube, and the grain seed discharging cavity is communicated with the shell through the grain seed discharging channel; when the seed conveying groove is aligned with the grain seed discharging channel, the grain seeds in the current seed conveying groove enter the grain seed discharging cavity through the grain seed discharging channel under an elastic pushing action of the corresponding push-pull piece, and then the grain seeds are discharged.

14. The precision grain seed sowing device capable of uniformly discharging grain seeds according to claim 13, wherein the grain seed replenishing assembly comprises the grain seed replenishing bin, a bottom of the grain seed replenishing bin extends into the grain seed discharging cavity, and the opening of the grain seed replenishing bin is formed in the bottom of the grain seed replenishing bin;
an upper part of the rotating plate extends into the shell, a lower part of the rotating plate extends into the grain seed discharging cavity, and a waist portion of the rotating plate is rotatably arranged on the shell through the articulated shaft; the fixed ring is provided with an elastic guide piece; a top of the rotating plate is supported by and slidably arranged on the elastic guide piece; when the elastic guide piece is in an unstressed state, the bottom of the rotating plate abuts against the opening of a grain seed replenishing bin; and when the elastic guide piece is in an unstressed state, the top of the rotating plate extends to an inner side of the fixed ring, so that the guide part is able to abut against the top of the rotating plate when the empty groove condition appears in the seed conveying groove.

15. The precision grain seed sowing device capable of uniformly discharging grain seeds according to claim 14, wherein a guide rail groove is formed in the conveying ring seat, the guide rail groove is provided with a guide block and is connected to the guide block through a connecting spring set, a support bracket in sliding fit with the rotating plate is rotatably arranged on the guide block, and the upper part of the rotating plate is slidably arranged on the support bracket.

16. The precision grain seed sowing device capable of uniformly discharging grain seeds according to claim 2, wherein a top channel of the shell is communicated with the grain seed supplying mechanism;
the grain seed supplying mechanism comprises a grain seed bin, the grain seed bin is fixedly installed above the shell, the grain seed bin is fixedly installed on a top of a frame, and the grain seed conveying mechanism is arranged at a middle of the frame; and
the grain seed bin is communicated with the top channel of the shell through a communication channel.

17. The precision grain seed sowing device capable of uniformly discharging grain seeds according to claim 3, wherein a top channel of the shell is communicated with the grain seed supplying mechanism;
the grain seed supplying mechanism comprises a grain seed bin, the grain seed bin is fixedly installed above the shell, the grain seed bin is fixedly installed on a top of a frame, and the grain seed conveying mechanism is arranged at a middle of the frame; and
the grain seed bin is communicated with the top channel of the shell through a communication channel.

18. The precision grain seed sowing device capable of uniformly discharging grain seeds according to claim 4, wherein a top channel of the shell is communicated with the grain seed supplying mechanism;
the grain seed supplying mechanism comprises a grain seed bin, the grain seed bin is fixedly installed above the shell, the grain seed bin is fixedly installed on a top of a frame, and the grain seed conveying mechanism is arranged at a middle of the frame; and
the grain seed bin is communicated with the top channel of the shell through a communication channel.

19. The precision grain seed sowing device capable of uniformly discharging grain seeds according to claim 5, wherein a top channel of the shell is communicated with the grain seed supplying mechanism;
the grain seed supplying mechanism comprises a grain seed bin, the grain seed bin is fixedly installed above the shell, the grain seed bin is fixedly installed on a top of a frame, and the grain seed conveying mechanism is arranged at a middle of the frame; and
the grain seed bin is communicated with the top channel of the shell through a communication channel.
